(19) United States
(12) Patent Application Publication
(10) Pub. No.: US 2006/0078764 A1
(43) Pub. Date: Apr. 13, 2006

(54) Dissolved fuel alkaline fuel cell

(76) Inventors: Laixia Yang, Xi'an (CN); Bor Z. Jang, Fargo, ND (US)

Correspondence Address: Bor Z. Jang, 2902 28th Ave. SW, Fargo, ND, 58103, US

(21) Appl. No.: 10/962,555

(22) Filed: Oct. 12, 2004

(51) Int. Cl. H01M 8/00; H01M 8/10

(52) U.S. Cl. 429/12; 429/30

(57) ABSTRACT

A dissolved-fuel alkaline fuel cell that comprises four main components: a) a fuel anode; b) a first oxygen cathode; c) an electrolyte in ionic contact with the anode and the first cathode, wherein the electrolyte comprises an alkaline solution and a first fuel dissolved in the alkaline solution; and d) a fuel reservoir comprising a solid fuel in physical contact with or in feeding relation to the alkaline solution. The first fuel and/or the solid fuel may be selected from the group consisting of NaBH₄, KBH₄, LiAlH₄, KH, NaH, LiBH₄, NaAlH₄, (CH₃)₃NHBH₃, NaCNBH₃, CaH₂, LiH, Na₂S₂O₃, Na₂HPO₃, Na₂HPO₂, K₂S₂O₃, K₂HPO₃, K₂HPO₂, NaCOOH and KCOOH. However, NaBH₄ and KBH₄ are the best choices for use as a fuel. The fuel reservoir can readily replenish a fuel into the electrolyte-fuel mixture or solution to ensure that the fuel cell continuously generates electrical current without an interruption or a voltage spike. The present fuel cell is simple in design, inexpensive to make, capable of providing a relatively high output voltage, and an exceptionally long service life.

### FIELD OF THE INVENTION

This invention relates generally to an alkaline fuel cell and more particularly to a high discharge capacity alkaline fuel cell that operates on an electrolyte containing a dissolved fuel and a reserved solid fuel.

### BACKGROUND OF THE INVENTION

A fuel cell converts chemical energy into electrical energy and some thermal energy by means of a chemical reaction between a fuel reactant (e.g., a hydrogen-containing fuel) and an oxidant (e.g., oxygen). As compared to other energy sources, fuel cells provide advantages that include low pollution, high efficiency, high energy density and simple fuel recharge. Fuel cells can be used in electrochemical engines, portable power supplies for various microelectronic and communication devices, standby power supply facilities, power generating systems, etc. Further, several types of fuel cells utilize renewable resources and provide an alternative to burning fossil fuels to generate power.

The chemical reaction of a fuel cell requires the presence of an electrolyte, electrodes and catalysts. Based on the electrolyte type, the fuel cell is classified as alkaline fuel cell (AFC), phosphoric acid fuel cell (PAFC), molten carbonate fuel cell (MCFC), solid oxide fuel cell (SOFC), and proton exchange membrane or polymer electrolyte membrane fuel cell (PEM-FC). Although PEM-type fuel cell has been a topic of most active R&D efforts during the past decade, other types of fuel cells remain to be commercially viable and have not been ignored. One particularly interesting type is the dissolved fuel alkaline fuel cell (DF-AFC).

As illustrated in FIG. 1, a prior-art DF-AFC 10 consists of a fuel anode 14, an air cathode 12, and a mixture 16 of electrolyte and fuel that separates the two electrodes. The electrolyte comprises an alkaline solution (e.g., KOH) with a fuel (such as sodium borohydride, NaBH₄) dissolved in it. The fuel anode carries an electro-catalyst (e.g., platinum, Pt) to promote the following anode reaction:
Anode: NaBH₄+8O⁻→NaBO₂+6H₂O+8e⁻ (1)
The water molecules generated at the anode go into the electrolyte solution, but a portion of water is then used at the cathode. The electrons generated at the anode travel to the cathode side of the fuel cell by passing through an external load that connects the anode and the cathode. Air or oxygen is supplied to the cathode where the electro-reduction of oxygen occurs, resulting in the following chemical reaction:
Cathode: 2O₂+4H₂O+8e⁻→8 OH⁻ (2)
Although the fuel is also fully in contact with the cathode, this has not caused any major detrimental effect because the cathode catalyst is not platinum. The overall fuel cell reaction is given by:
Overall: NaBH₄+2O₂→NaBO₂+2H₂O (3)
It is of great technological interest to note that eight (8) electrons are generated per fuel molecule consumed. Further, thermodynamic calculations indicate that the theoretical open circuit voltage (OCV) of sch a cell is approximately 1.64 V, which is significantly higher than that achievable by a hydrogen fuel cell (typically 1.2 V). These two features indicate that DF-AFC based on alkali metal borohydride such as NaBH₄ potentially have an exceptionally high power density.

However, the catalyst (e.g., Pt) that promotes the direct borohydride oxidation of Eq. (1) also tends to promote the hydrolysis reaction:
Side Reaction: NaBH₄+2H₂O→NaBO₂+4H₂ (4)
This side reaction, if not properly controlled, could result in a significant voltage reduction and/or power loss. However, we have discovered that the 4 H₂ molecules produced, if captured or constrained by the surface pores of a highly porous anode layer, may be oxidized immediately to produce 8 H⁺ and 8 electrons via the following reaction:
Reaction of Constrained H₂: 4H₂→8H⁺+8e⁻; OCV=1.2 V (5)
Although a lower voltage of 1.2 V is generated, the eight electrons may be recovered if the anode structure is properly designed and the side reaction, Eq. (4) does not proceed too quickly. It is also known that if the concentration of NaBH₄ in the electrolyte is low and the electrolyte concentration is high, the side reaction, Eq. (4), is significantly slowed down.

Finkelshtain, et al. (U.S. Pat. No. 6,773,470, Aug. 10, 2004) disclosed a fuel composition for fuel cells. The composition includes a polar solvent such as water, a first portion of a fuel dissolved in the solvent at a saturated concentration, and a second portion of the same fuel suspended in the solvent to serve as a reservoir of fuel which replenishes the fuel as the dissolved portion is consumed. A special advantage of this composition is that this fuel reservoir could keep the fuel cell operate for an extended period of time. However, when the fuel is a hydride such as NaBH₄, the fuel composition must also include an additive such as an alkali for stabilizing the fuel. Additionally, this fuel composition for fuel cell has several drawbacks: (1) As indicated in FIG. 1 of U.S. Pat. No. 6,773,470, the fuel is intended for being contained in a designated fuel chamber separate from the electrolyte chamber. These two bulky chambers make the fuel cell structure bulky and complex. (2) The fuel must be dissolved in the solvent at a saturated concentration. Such a high NaBH₄ concentration tends to lead to a fast side reaction (hydrolysis of NaBH₄), which is a highly undesirable feature. (3) An additive is required to stabilize the fuel. (4) The suspended portion of the fuel, in the form of fine solid particles having excessively high surface area, could be subject to high parasitic (uncontrolled, undesirable) reactions that do not contribute to the provision of electrons to the external load. (5) The fuel solution containing a large proportion of suspended fuel particles, if implemented as an electrolyte between the fuel anode and the air cathode, could significantly reduce the conductivity of OH⁻ ions, thereby adversely affecting the high power performance of an AFC.

Lee, et al. (U.S. Pat. No. 5,599,640, Feb. 4, 1997) disclosed a fuel cell that comprises an aqueous alkaline solution of electrolyte containing a hydrogen-releasing agent (selected from the group consisting of NaBH₄, KBH₄, LiAlH₄, KH and NaH), an oxygen electrode as a cathode and a hydrogen storage alloy electrode as an anode. In this case, ideally, the hydrogen that is generated by a hydrogen-releasing agent should react with the anode metal alloy to form a metal hydride, which serves to chemically retain or store hydrogen. Unfortunately, such a metal hydride forming reaction proceeds at a reasonable speed only at a relatively high temperature. At ambient temperature, a significant portion of hydrogen produced by the hydrogen-releasing agent escapes (without being converted into a hydride) and the fuel is wasted. After a limited number of cycles of repeated metal hydride formation and decomposition steps, the anode tends to become porous, weakened or even broken. This is because re-deposition of metal alloy back to the anode is a random process and normally would not occur to the original spot of the anode. This problem presents a severe system reliability concern for a DF-AFC. Further, since the electrochemical reactions are mediated by the metal alloy and metal hydride at the anode, the reactions are basically similar to those in a hydrogen/oxygen type fuel cell having a theoretical OCV of 1.2 V rather than 1.64 V. This is clearly a disadvantage as compared with the traditional DF-AFC represented by Eq. (1).

It is therefore an object of the present invention to provide an alkaline fuel cell that has a high discharge capacity and a long operating life.

It is another object of the present invention to provide a dissolved fuel alkaline fuel cell (DF-AFC) that has a simple or non-complex configuration.

Another object of the present invention is to provide a reliable DF-AFC that has a relatively high voltage.

These and other objects of the invention are achieved by the fuel cell of the present invention, briefly described as follows:

### SUMMARY OF THE INVENTION

The present invention provides a dissolved-fuel alkaline fuel cell that comprises four components: a) a fuel anode; b) a first oxygen cathode; c) an electrolyte in ionic contact with the anode and the first cathode, wherein the electrolyte comprises an alkaline solution and a first fuel dissolved in the alkaline solution; and d) a fuel reservoir comprising a solid fuel in physical contact with or in feeding relation to the alkaline solution. The first fuel and/or the solid fuel may be selected from the group consisting of NaBH₄, KBH₄, LiAlH₄, KH, NaH, LiBH₄, NaAlH₄, (CH₃)₃NHBH₃, NaCNBH₃, CaH₂, LiH, Na₂S₂O₃, Na₂HPO₃, Na₂HPO₂, K₂S₂O₃, K₂HPO₂, NaCOOH and KCOOH. Actually, all the hydrides and borohydrides of alkali metals, alkaline rare earth metals and their alloys can be used in the present invention. However, NaBH₄ and KBH₄ are the best choices for serving as a fuel. The fuel reservoir can readily replenish a fuel into the electrolyte-fuel mixture or solution to ensure that the fuel cell continuously generates electrical current without an interruption or a voltage spike. The present fuel cell is simple in design, inexpensive to make, capable of providing a relatively high output voltage, and an exceptionally long service life.

### BRIEF DESCRIPTION OF THE DRAWINGS

FIG. 1 Schematic of a prior-art dissolved fuel alkaline fuel cell (DF-AFC).

FIG. 2 (a) Schematic of a DF-AFC according to one preferred embodiment of the present invention; (b) Schematic of a DF-AFC according to another preferred embodiment of the present invention.

FIG. 3 A DF-AFC wherein the anode has two primary catalyst-coted surfaces in contact with the electrolyte-fuel solution. Such a configuration results in a higher current output.

FIG. 4 A DF-AFC wherein the anode and the cathode are separated by a highly porous, ion-conducting layer which is capable of being soaked with the electrolyte-fuel solution through capillary action.

FIG. 5 A sandwich-type DF-AFC wherein a fuel anode is placed between two oxygen cathodes. Such a configuration results in a higher current output.

FIG. 6 The discharge curves of a NaBH₄ fuel-based DF-AFC under different operating conditions.

FIG. 7 The discharge voltage response of a DF-AFC without a fuel reservoir (Curve D) and with a fuel reservoir (Curves E and F).

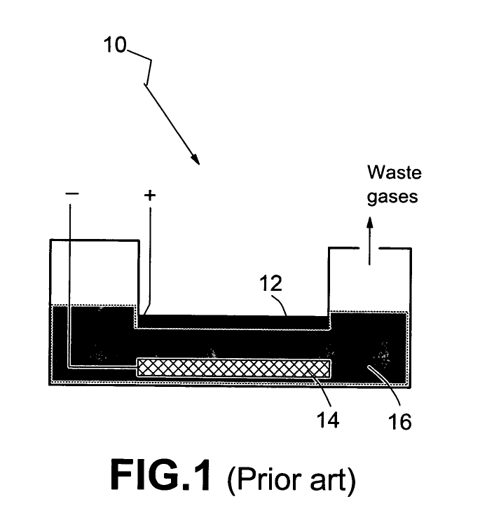

### DETAILED DESCRIPTION OF THE PREFERRED EMBODIMENTS

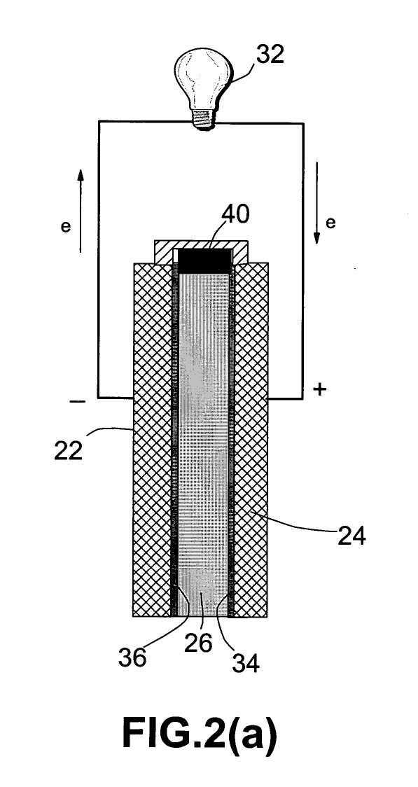

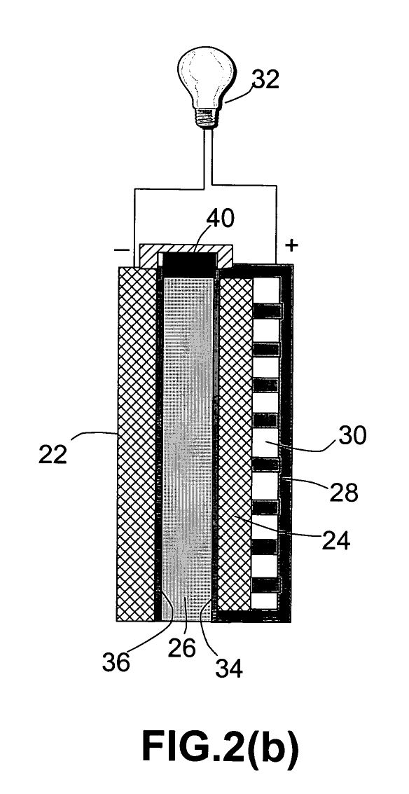

In one preferred embodiment, as illustrated in FIG. 2(a), the present invention provides a dissolved-fuel alkaline fuel cell that is primarily composed of (a) a fuel anode 22; (b) an oxygen cathode 24 (also referred to as the first oxygen cathode); (c) an electrolyte 26 in ionic contact with the anode and the cathode with the electrolyte comprising an alkaline solution and a first fuel dissolved in the alkaline solution (also herein referred to as an electrolyte-fuel mixture); and (d) a fuel reservoir 40 comprising a solid state fuel in physical contact with or in feeding relation to the alkaline solution.

The fuel anode 22 is preferably a non-consumable electrode that is electronically conducting so that it may serve two primary functions: (1) as a backing layer or carrier for electro-catalyst 36 that promotes the anode reaction (e.g., Eq. (1) or the like) to produce electrons and (2) as an electron collector through which the produced electrons are transported to an external load (e.g., a bulb 32 in FIG. 2(a)). The highly conducting carbon paper, carbon cloth or graphite plate is a good fuel anode material for practicing the present invention. The surface of the anode 22 that faces the electrolyte preferably is highly porous with an ultra-high pore surface area. The surface pores are such that the hydrogen gas molecules produced by a side reaction like Eq. (4) are constrained to stay in or near the pores for a sufficiently long time so that they can be oxidized according to Eq. (5), as mediated and promoted by the nearby electro-catalyst 36 (e.g., platinum, Pt).

The oxygen electrode 24 is made of a material selected so that oxygen can be easily engaged in an electro-reduction reaction on its surface. For example, such an electrode may include a carbon paper or cloth, nickel-dispersed carbon paper or cloth, nickel electrode, and the like, which preferably have a double-layer structure consisting of a hydrophilic side interfaced with the electrolyte 26 and a hydrophobic side interfaced with atmosphere. A hydrophobic material such as polytetrafluoroethylene (PTFE, e.g., Teflon®) may be added to one surface of the cathode layer. The oxygen cathode 24 should be permeable to oxygen gas molecules so that oxygen could migrate to the cathode catalyst layer 34 that promotes Eq. (2) to produce the conducting ions OH⁻. The oxygen cathode should comprise no catalyst that can significantly promote oxidation of the dissolved first fuel at the cathode. Otherwise, this oxidation on the cathode side would reduce the fuel cell efficiency because the electrons produced are wasted.

The electrolyte that can be employed in the present invention may comprise an alkaline solution 26 with pH>7; for example, KOH, NaOH, LiOH, or the like. A chemical species (first fuel) that can react with OH⁻ to produce electrons at the anode is added to the alkaline solution of electrolyte. This fuel may be selected from the group consisting of NaBH₄, KBH₄, LiAlH₄, KH, NaH, LiBH₄, (CH₃)₃NHBH₃, NaAlH₄, NaCNBH₃, CaH₂, LiH, Na₂S₂O₃, Na₂HPO₃, Na₂HPO₂, K₂S₂O₃, K₂HPO₃, K₂HPO₂, NaCOOH, KCOOH, and their combinations. All the hydrides and borohydrides of alkali metals, alkaline rare earth metals and their alloys can be used in the present invention. These materials are salts whose anions have standard reduction potentials in water that are more negative than the standard reduction potential of a hydrogen electrode in water. Preferably, the first fuel is selected from the hydride group consisting of NaBH₄, KBH₄, LiAlH₄, KH, NaH, LiBH₄, (CH₃)₃NHBH₃, NaAlH₄, NaCNBH₃, CaH₂ and LiH since they have relatively high reduction potentials. They are also good hydrogen releasing agents that promote anode reactions. The first two, NaBH₄ and KBH₄, are particularly effective first fuel materials and are the most preferred in the present invention. The fuel may be used preferably in an amount of 0.01 to 50.00% by weight on the basis of the total weight of the alkaline solution of electrolyte. When the amount of the first fuel used is less than 0.01%, the amount of electrons to be produced will be too low for the fuel cell to provide useful power. When the amount of first fuel dissolved is more than the upper limit of the range, the fuel is saturated in the alkaline solution. This tends to promote the side reaction (e.g., Eq (4)), resulting in a lower operating voltage. In order to enhance the ionic conductivity of the electrolyte 26 (when KOH or NaOH is used, for example), LiOH may be added to the alkaline solution of electrolyte in an amount of 0.01 to 0.1% by weight.

It may be noted that the selection of a fuel to be dissolved in the alkaline electrolyte solution is dictated by the types of anode catalyst and cathode catalyst used. The anode catalyst should be selected to promote the anode reaction so that it may proceed at a sufficiently high rate even at ambient temperature or at a temperature not too much higher than the ambient temperature. The cathode catalyst should not promote the anode reaction that produces electrons at the cathode, which electrons otherwise would be wasted. For instance, if NaBH₄ is used as a dissolved fuel, platinum is an effective anode catalyst, but platinum should not be used at the cathode side. Several other oxygen-reducing catalysts (e.g., nanometer-scaled Ni and TiO₂ particles) may be used instead.

The fuel reservoir 40 may simply be a block or rod of a solid fuel in physical contact with the alkaline solution or in feeding relation thereto. This reservoir fuel may be the same as or different from the first fuel composition and, again, may be selected from the group consisting of NaBH₄, KBH₄, LiAlH₄, KH, NaH, LiBH₄, (CH₃)₃NHBH₃, NaAlH₄, NaCNBH₃, CaH₂, LiH, Na₂S₂O₃, Na₂HPO₃, Na₂HPO₂, K₂S₂O₃, K₂HPO₃, K₂HPO₂, NaCOOH and KCOOH. Again, the first two members are the most preferred. This reservoir is used to replenish the dissolved fuel as the dissolved fuel in the alkaline solution is being consumed. This reservoir may comprise a block or rod of solid fuel (e.g., NaBH₄) that remains in constant contact with the alkaline solution and, hence, continuously provides dissolved fuel thereto. The size and shape of this reservoir (a block or rod) may be predetermined so as to provide a desired, constant current or power level. Alternatively, this reservoir may be designed in such a fashion that the rod is fed into the alkaline solution by a desired amount (when needed) to provide a desired but possibly varying current or power level on demand. A simple mechanism may be installed that allows advancing (inserting) or retreating (pulling back) of the rod on demand. Another alternative form of the reservoir comprises a chamber (e.g., simply a plastic bag) that contains a fuel in the powder form. The powder is injected into the electrolyte when needed. This fuel reservoir is capable of keeping the fuel cell operate for an extended period of time. Due to the fact that the cathode active material, O₂, is not stored in the fuel cell system, but supplied from the ambient air, this type of electrochemical cell has a very high power density.

Schematically shown in FIG. 2(a) is a unit cell of the invented DF-AFC, which typically provides a voltage of 0.72 V to 0.95 V per cell at room temperature and higher than 1.05 V at higher temperatures (e.g., 50-90° C.). To provide a higher voltage output, a desired number of unit cells must be connected in series. A compact configuration is to form a stack of several unit cells with the anode (negative electrode) of a first unit cell connected to the cathode (positive electrode) of a second unit cell. The unit cell design as shown in FIG. 2(b) is a particularly good design that provides an oxygen gas flow field plate 28 containing oxygen flow channels 30 that allow oxygen to reach the cathode layer, which is itself permeable to oxygen gas. The oxygen gas has to reach the cathode catalyst layer 34 where the oxygen is reduced according to Eq. (2) or the like. The oxygen gas flow field plate 28 is in direct contact with the oxygen cathode layer and in gas feeding relation to the cathode layer. The oxygen gas flow field plate 28 must be electrically conducting so as to readily transport the electrons that come from the external circuit into the cathode side to reach the interface between the cathode and the electrolyte. It may be noted that this configuration is simpler than that of a stack of polymer electrolyte membrane (PEM)-based fuel cell units. The latter stack needs two bipolar plates (one for hydrogen fuel transport and the other for oxygen) per unit cell while the former needs only one plate for oxygen transport. Unit cells may also be connected in parallel to provide a higher current output. They may also be connected both in series and in parallel.

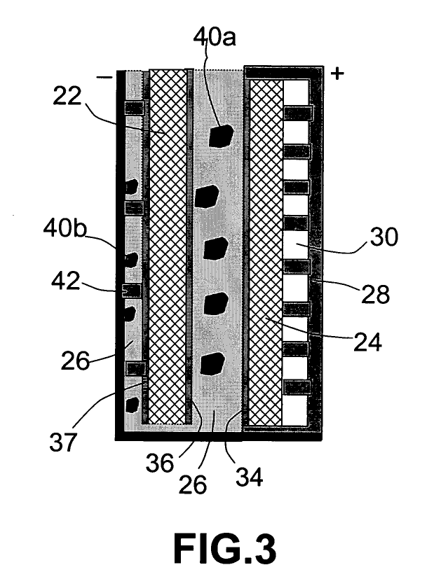

Another preferred embodiment of the present invention, schematically shown in FIG. 3, is a unit cell that contains a fuel anode 22 with both primary surfaces coated with the anode catalyst 36, 37. This will provide a higher current output since more electrons can be produced and collected. This is possible due to the facts that an anode active fuel is dissolved in the electrolyte which flows around both sides of the anode and that the cathode catalyst does not significantly promote electron-producing reaction such as in Eq. (1). Provided that a sufficient flow rate of oxygen is supplied to the cathode side, the electrochemical reactions can proceed very fast to provide a high current output. An anode current collector 42 is employed to facilitate the transport of electrons and serial connections between unit cells. FIG. 3 shows that a number of solid fuel particles 40a, 40b have just been released from a fuel reservoir into the electrolyte.

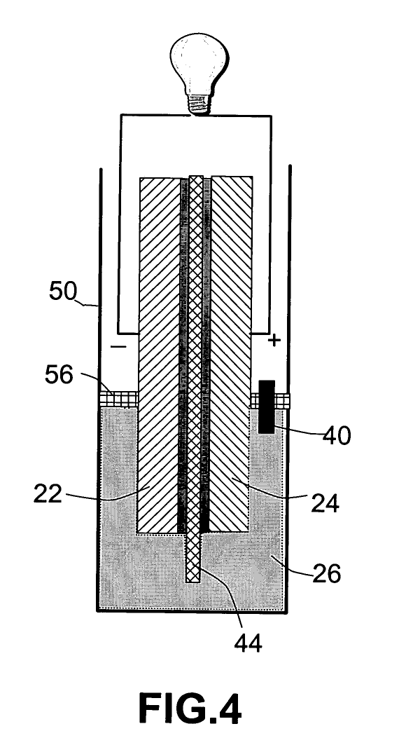

FIG. 4 shows another possible configuration of a unit cell of the presently invented alkaline fuel cell. The fuel anode 22 and the oxygen cathode 24 are separated by a highly porous separator plate 44 that is capable of absorbing the dissolved fuel-containing electrolyte through capillarity pressure from the surrounding electrolyte-fuel solution 26. This separator 44 also allows ions such as OH⁻ to freely pass through. Portions of the electrodes and the entire volume of electrolyte are sealed inside a container 50 by using a proper sealing mechanism 56 that still allows the fuel reservoir 40 to operate. This configuration is very simple and inexpensive to make.

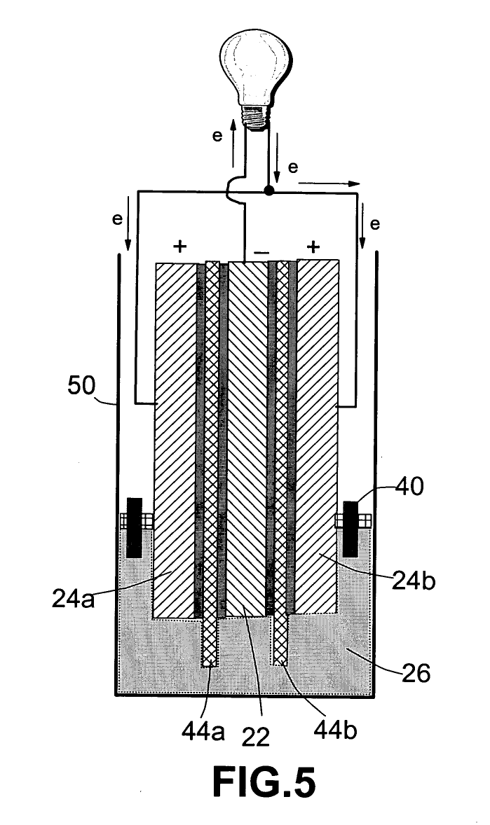

Another attractive design for a unit cell with a high-current output is schematically shown in FIG. 5, wherein two porous and ion-conducting separators 44a, 44b are used to separate a fuel anode 22 and two oxygen cathodes 24a, 24b. Again, the separators are capable of absorbing the fuel-electrolyte mixture 26 via capillary action. The fuel anode is essentially sandwiched between the two oxygen cathodes. The electrons are produced at the two catalyst-carrying primary surfaces of the anode 22 and collected by the anode layer to transport to an external load. The electrons come back to the unit cell through both cathode layers 24a, 24b. A fuel reservoir 40 provides and replenishes fuel to the electrolyte continuously or intermittently on demand. The electrolyte is sealed in a container 50, but still allowing sufficient exposed cathode surfaces to access oxygen in the surrounding air. Unit cells of this type, having a high current and high voltage, may be connected in series, in parallel, or both to meet desired current, voltage, and power requirements.

The dissolve-fuel alkaline fuel cell of the present invention has a higher electrochemical reaction rate than those of the prior art fuel cells. It can operate at room temperature or slightly above to produce a large amount of energy due to its high energy density of 6,200 Ah/kg or more (for NaBH₄ or KBH₄). With an uninterrupted and convenient supply of fuel through the electrolyte from a reservoir to the anode and unlimited supply of oxygen from open air to the oxygen electrode, the cell can produce electric current continuously for an exceptionally long period of time.

The present invention is further illustrated in the following examples. The examples are presented for illustrative purposes only and should not be construed as limiting the invention, which is properly defined by the claims.

### EXAMPLE 1

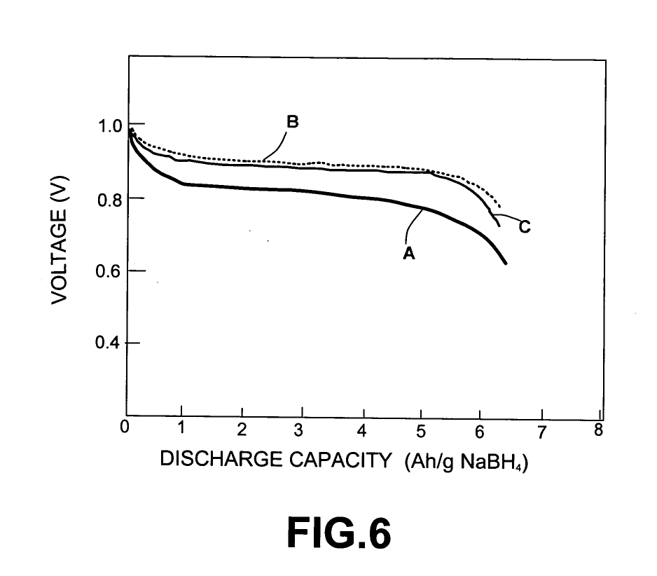

An aqueous solution containing 1 gram of NaBH₄ in 500 cc of 6M KOH was used. A carbon paper coated with platinum-carrying carbon particles was used as an anode, with dimensions of approximately 10 mm×10 mm×1 mm. This Pt/C anode was made by dispersing 5% by weight of platinum in VULCAN XC-72 (acquired from E-TEK; a carbon black). The oxygen cathode was prepared by coating an appropriate amount of nickel powder to one side of a carbon paper and coating some Teflon (or polytetrafluoroethylene, a hydrophobic material that repels water) powder to the opposite side. A unit cell like the one shown in FIG. 5 was allowed to discharge at 10 mA as a function of time while its discharge voltage was measured. The results are shown by a discharge curve (Curve A, 25° C.) in FIG. 6, which indicates that the discharge voltage was about 0.8 V with an over-voltage of about 0.3 V. Such over-voltage was mostly due to the reaction slowness at the oxygen cathode. However, if pure oxygen gas, not air, is supplied to the oxygen cathode and the volume of oxygen to be supplied is increased, the over-voltage was found to decrease. With an oxygen flow rate of 0.1 liter/min, the discharge voltage at 25° C. was 0.92 V (Curve B in FIG. 6), which is higher than the value achieved by Lee, et al (U.S. Pat. No. 5,599,640) under comparable conditions. However, with ambient air (not pure oxygen) and a higher fuel cell operating temperature (50° C.), the performance of the fuel cell (Curve C) was found to be comparable to that when pure oxygen was used and the fuel cell operates at room temperature. In all three cases, the discharge capacity was about 6,200 mAh per gram of NaBH₄.

### EXAMPLE 2

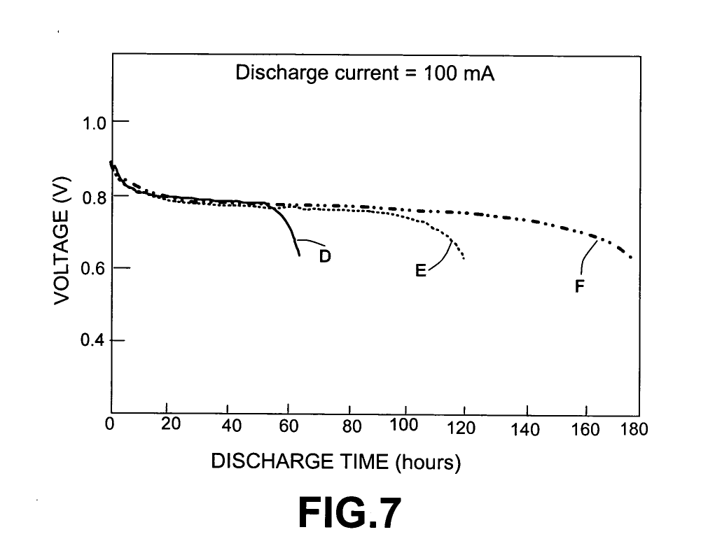

Three samples similar to that used in Example 1 were prepared, but each containing 1 gram of KBH₄ as a dissolved fuel and with no fuel reservoir (Sample D), with a fuel reservoir in the form of a solid KBH₄ rod (1 gram), and with a fuel reservoir in the form of a solid KBH₄ rod (2 grams), respectively. Each fuel cell sample was discharged at a discharge current of 100 mA. In both Samples E and F, the KBH₄ rod was in constant contact with the alkaline solution. FIG. 7 demonstrates that the presently invented fuel cell is capable of continuously generating current (without an interruption or voltage spike) when a fuel reservoir is implemented to be in physical contact or in feeding relation to the electrolyte solution. This is in contrast to the alkaline fuel cell disclosed by Lee, et al. (U.S. Pat. No. 5,599,640) that exhibited a periodic voltage spike whenever an additional amount of fuel was added to the cell (e.g, FIG. 6 of U.S. Pat. No. 5,599,640). The voltage achievable by the presently invented fuel cell is also higher than that of Lee's fuel cell.

It may be noted that the electrochemical reactions involved in the dissolved-fuel alkaline fuel cell produce a by-product such as NaBO₂, which is a solid. When the amount of NaBO₂ in the electrolyte becomes excessive, resulting in a significantly lower ionic conductivity, the electrolyte must be replaced with a fresh amount of alkaline solution. This can be advantageously accomplished by retreating the fuel reservoir and allowing the dissolved fuel to be fully utilized. Fortunately, alkaline solutions such as KOH are the least expensive electrolyte among all the electrolytes used in all current fuel cell types.

1. A dissolved-fuel alkaline fuel cell comprising:
a) a fuel anode;
b) a first oxygen cathode;
c) an electrolyte in ionic contact with said anode and said cathode, said electrolyte comprising an alkaline solution and a first fuel dissolved in said alkaline solution; and
d) a fuel reservoir comprising a solid fuel in physical contact with or in feeding relation to said alkaline solution.

2. The fuel cell as defined in claim 1, wherein said first fuel and/or said solid fuel is selected from the group consisting of NaBH₄, KBH₄, LiAlH₄, KH, NaH, LiBH₄, (CH₃)₃NHBH₃, NaAlH₄, NaCNBH₃, CaH₂, LiH, Na₂S₂O₃, Na₂HPO₃, Na₂HPO₂, K₂S₂O₃, K₂HPO₃, K₂HPO₂, NaCOOH, KCOOH, and combinations thereof.

3. The fuel cell as defined in claim 1, wherein said first fuel and/or said solid fuel is selected from the group consisting of hydrides or borohydrides of alkali metals, alkaline rare earth metals and alloys thereof

4. The fuel cell as defined in claim 1, wherein said first fuel comprises NaBH₄ or KBH₄.

5. The fuel cell as defined in claim 1, wherein said alkaline solution comprises an alkaline selected from the group consisting of KOH, NaOH, LiOH, and combinations thereof.

6. The fuel cell as defined in claim 1, wherein said first fuel is dissolved in said alkaline solution up to a concentration that is lower than a saturation concentration.

7. The fuel cell as defined in claim 2, wherein said first fuel is dissolved in said alkaline solution up to a concentration that is lower than a saturation concentration.

8. The fuel cell as defined in claim 4, wherein said first fuel is dissolved in said alkaline solution up to a concentration that is lower than a saturation concentration.

9. The fuel cell as defined in claim 1, wherein said first fuel is dissolved in said alkaline solution up to a concentration that is lower than 50% by weight on the basis of the total weight of the electrolyte.

10. The fuel cell as defined in claim 1, wherein said oxygen cathode comprises a carbon paper, a carbon cloth, a nickel electrode, or a combination thereof.

11. The fuel cell as defined in claim 10, wherein said oxygen cathode further comprises a hydrophobic material.

12. The fuel cell as defined in claim 1, further comprising a second oxygen cathode in ionic contact with said electrolyte, wherein said fuel anode is sandwiched between said first oxygen cathode and said second oxygen cathode.

13. The fuel cell as defined in claim 1, wherein said fuel anode comprises a carbon paper, carbon cloth, or graphite plate.

14. The fuel cell as defined in claim 1, wherein said fuel anode comprises surface pores and an anode electro-catalyst effective for promoting oxidation of said first fuel to produce electrons.

15. The fuel cell as defined in claim 1, wherein said first oxygen cathode comprises no catalyst that significantly promotes oxidation of said first fuel.

16. The fuel cell as defined in claim 1, further comprising an oxygen gas flow field plate in contact with said first oxygen cathode and in gas feeding relation thereto.

17. A stack of multiple fuel cells connected in series, in parallel, or in a combination of serial and parallel connections, wherein at least one fuel cell is as defined in claim 1.

18. A stack of multiple fuel cells connected in series, in parallel, or in a combination of serial and parallel connections, wherein at least one fuel cell is as defined in claim 16.
